(19) United States
(12) Patent Application Publication
(10) Pub. No.: US 2008/0072474 A1
(43) Pub. Date: Mar. 27, 2008

(54) INSECT-TRAPPING DEVICE

(76) Inventor: Chien-Hsun Chen, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/534,852

(22) Filed: Sep. 25, 2006

(51) Int. Cl. A01M 1/10; A01M 1/02

(52) U.S. Cl. 43/122; 43/107

(57) ABSTRACT

An insect-trapping device is composed of a container and two caps respectively mounted on two ends of the container. One cap has multiple ventilation holes defined thereon and the other cap combines with an inducer that particularly emits special scent (pheromone) to attract insects. The container is preferably made of resilient material and foldable so as to keep the volume of the insect-trapping device adjustable. Particularly, the insect-trapping device mimics a lantern to have a decorative and pleasant appearance when the device is suspended or located.

### BACKGROUND OF THE INVENTION

1. Field of the Invention

The present invention relates to an insect-trapping device, and more particularly to an easily composed and portable insect-trapping device.

2. Description of Related Art

By having the advanced medical technology, most infectious diseases can be examined and treated by medication. However, patients still have to suffer the disease suffering the disease until effective medication is applied to them. Therefore, we certainly hope to prevent the infectious disease in advance. With regard to some infectious diseases spread by insect such as flies or mosquitoes in particular, people usually have some insect-trapping devices to eliminate the disease-carrying insects.

Incenses or electrical incenses are commonly used in the household, which release special smells to repel or poison the insects. Although the incenses and the electrical incenses are effective instantly to kill the insects, drug resistance helps the insects to survive and is further modified to resist the chemicals of the incenses by gene evolution after several short generations. Therefore, a new electrical trapping lamp is developed to substitute the conventional incenses and has a light source and an electrified grill surrounding the light source. The electrical trapping lamp is to attract the insects by light because most insects have photokinesis. When the insects touch the electrified grill by the light attraction, the electricity shocks the insects immediately to kill and burn the insects. However, accidents happen usually because the electrical trapping lamp has to be kept lighting all the time. First, electrical sparkling caused by short circuit might incur fire accident once the insects are stuck on the electrified grill. Second, kids might touch the exposed electrified grill accidentally and get electricity shock when play in the household.

According to above description, the conventional insect-trapping devices still have some drawbacks in use.

### SUMMARY OF THE INVENTION

A main objective of the present invention is to provide an insect-trapping device that can be folded to diminish its volume for convenient storage and transportation.

Another main objective of the present invention is to provide an insect-trapping device that can be hang at high places to avoid inadvertent touches especially by kids.

Still another main objective of the present invention is to provide an insect-trapping device that contains an inducer, such as pheromone, to attract and entrap insects inside the device and further eliminates the insects by other means.

Further another main objective of the present invention is to provide an insect-trapping device that not only entraps insects but also mimics a lantern to have a decorative and pleasant appearance when the device is suspended or located in use. Therefore, the insect-trapping device does not spoil the beauty of indoor decoration.

To achieve the foregoing objective, the insect-trapping device comprises:

a foldable container with two ends;

two caps respectively mounted on the two ends of the foldable container, wherein one cap has multiple ventilation holes and the other cap is adapted to keep an inducer for insects.

By having the foldable container, the insect-trapping device can be diminished for convenient storage and transportation.

Further benefits and advantages of the present invention will become apparent after a careful reading of the detailed description with appropriate reference to the accompanying drawings.

### BRIEF DESCRIPTION OF THE DRAWINGS

FIG. 1 is a perspective of an insect-trapping device in accordance with the present invention;

FIG. 2 is an operational cross-sectional side view of the insect-trapping device in FIG. 1;

FIG. 3 is a partially exploded perspective view of the insect-trapping device, wherein a top cap is detached;

FIG. 4 is a partially exploded perspective view of the insect-trapping device, wherein a bottom cap is detached; and

FIG. 5 is a side view of the insect-trapping device that is folded.

### DETAILED DESCRIPTION OF THE PREFERRED EMBODIMENT

An insect-trapping device in accordance with the present invention comprises a container and two caps respectively mounted on two ends of the container. One cap has multiple ventilation holes defined thereon and the other cap combines with an inducer that particularly emits special scent (pheromone) to attract insects. The container is made of resilient material and foldable so as to keep the volume of the insect-trapping device adjustable. Particularly, the insect-trapping device mimics a lantern to have a decorative and pleasant appearance when the device is suspended or located.

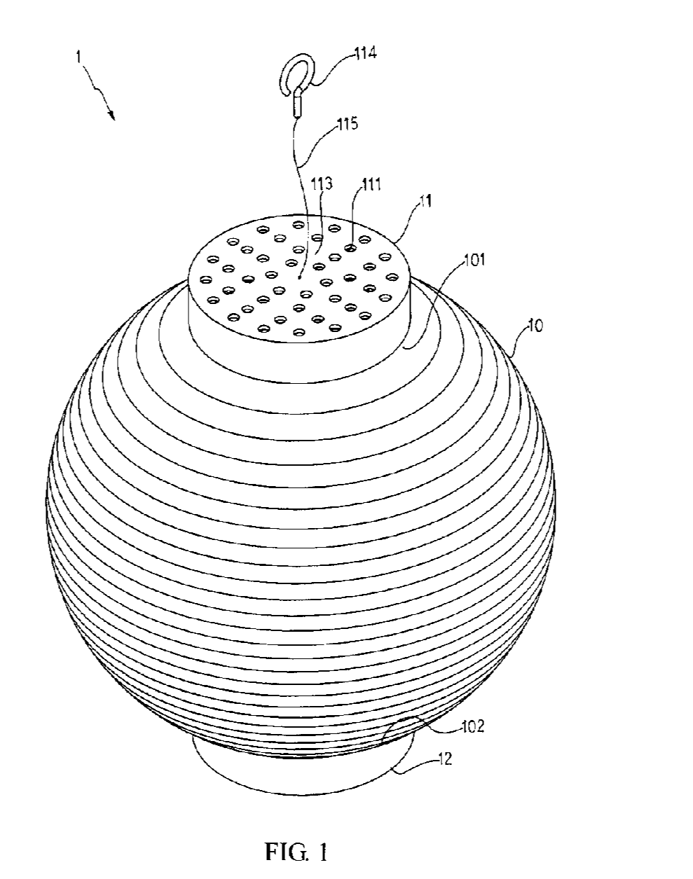

With reference to FIG. 1, a preferred embodiment of the insect-trapping device is composed of an extendable and foldable container 10, a top cap 111 and a bottom cap 12. The top cap 11 has multiple ventilation holes 111 and is detachably mounted on an upper end of the container 10. The bottom cap is adapted to receive an inducer 121 (particular pheromone in solid or liquid form) and detachably mounted on a lower end 102 of the container 10 to achieve the insect-trapping device 1. Selectively, the container 10 can be placed transversally in other designs and operations.

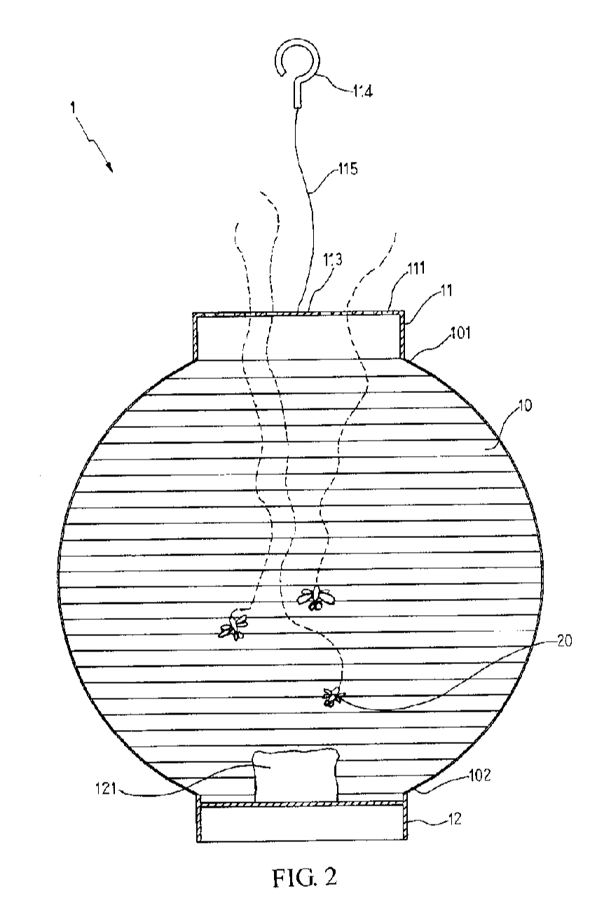

With reference to FIG. 2, the insect-trapping device 1 is adapted to suspend at a high place to spread a special scent (pheromone) from the inducer 121 on the bottom cap 12 as far as possible. When the insects detect the scent, the insects instinctively fly to the insect-trapping device 1, enter the container 10 via the ventilation holes 111 and are trapped inside. The pheromone keeps the insects staying inside the container 10. Then, the insects are eliminated by other means when the insects are entrapped therein.

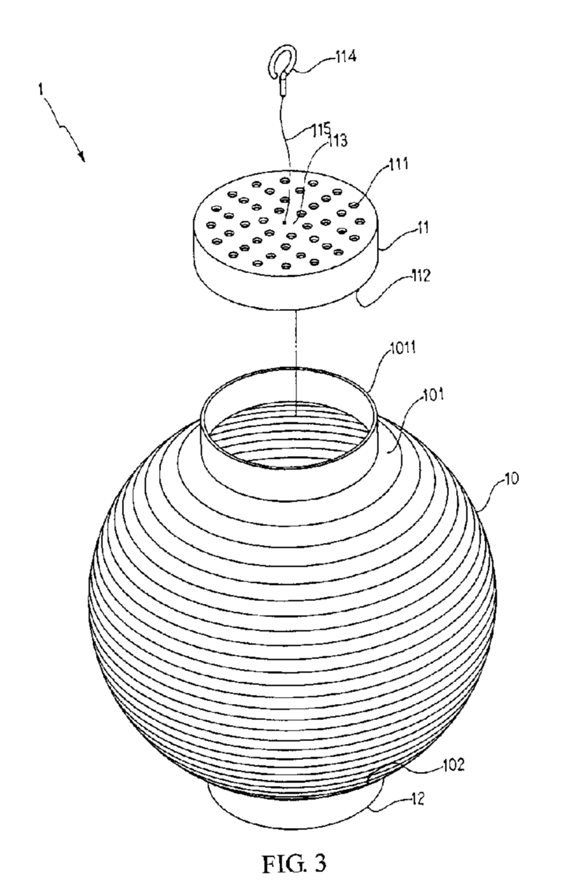

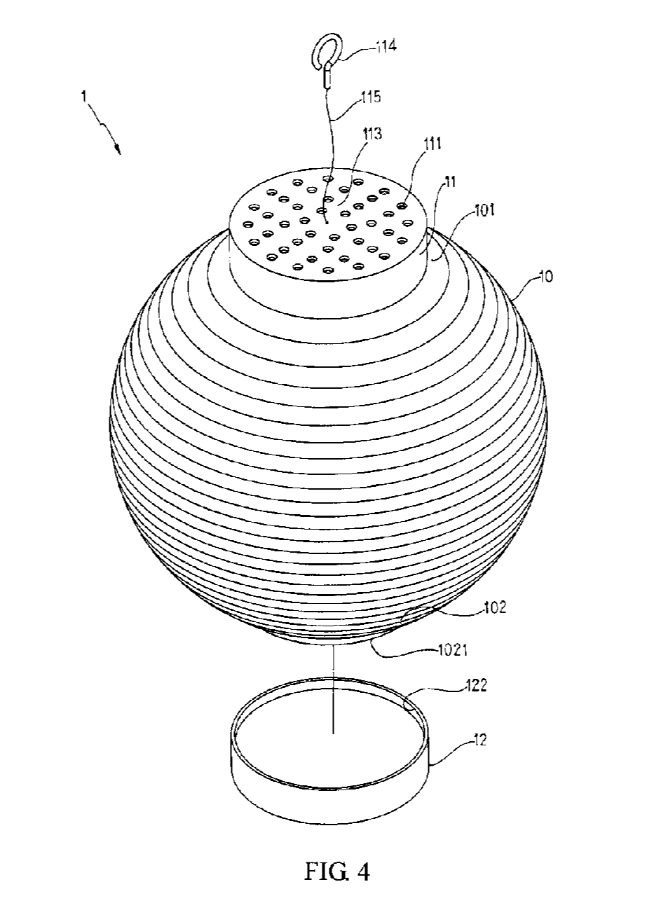

With reference to FIGS. 3 and 4, the container 10 of the insect-trapping device 1 further has two engaging portions 1011, 1021 formed on the upper and lower ends 101, 102. Correspondingly, the top cap 11 has an engaging portion 112 to combine with the engaging portion 1011 on the upper end 101 of the container 10. The bottom cap 12 has an engaging portion 122 to combine with the engaging portion 1021 on the lower end 102 of the container 10. Combinations between the top and bottom caps 11, 12 and the container 10 can be selectively achieved by means of snug attachment, threading combination, buckles or other conventional ways.

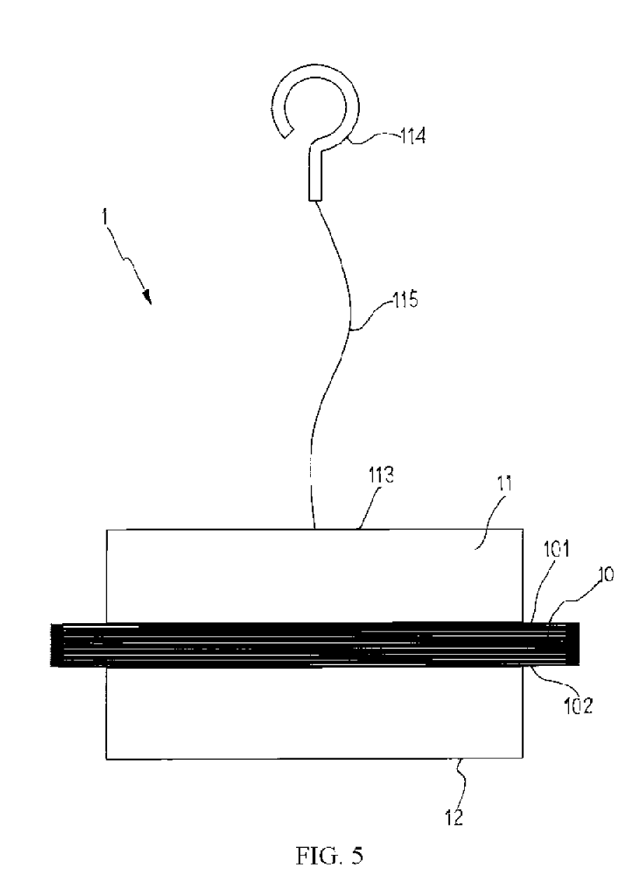

With reference to FIG. 5, the container 10 in the insect-trapping device 1 is substantially sphere-shaped (lantern-like, particularly having a pleasing appearance) and has multiple annular sections flexibly combined at joints one by one in parallel between the top and bottom ends to perform the foldable body of the container 10. Thereby, the container 10 can be compressed to significantly diminish its volume for storage or transportation convenience when the insect-trapping device is not used. Certainly, the container 10 can be quickly extended by pulling two ends to construct the main body of the insect-trapping device for use.

As shown in FIGS. 1 to 5, the insect-trapping device further has a suspension device comprising a hook 112 and a string 115. The hook 112 is directly formed or indirectly mounted on a top face 113 on the upper cap 11. If the hook 12 is indirectly mounted on the top face of the upper cap 11, the string 115 extends between the hook 114 and the top face 113 of the upper cap 11 for combination.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An insect-trapping device comprising:
a foldable container with two ends;
two caps respectively mounted on the two ends of the foldable container, wherein one cap has multiple ventilation holes and the other cap is adapted to keep an inducer for insects.

2. The insect-trapping device as claimed in claim 1, wherein the container further has two engaging portions respectively formed at the two ends thereon.

3. The insect-trapping device as claimed in claim 1, wherein combinations between the two caps and the container are achieved by snug attachment, threading combination or buckles.

4. The insect-trapping device as claimed in claim 1, wherein the two ends of the container are a top end and a bottom end;
one of the two caps mounted on the top end comprises a hook directly formed thereon.

5. The insect-trapping device as claimed in claim 3, wherein the two ends of the container are a top end and a bottom end;
one of the two caps mounted on the top end comprises a hook directly formed thereon.

6. The insect-trapping device as claimed in claim 1, wherein the two ends of the container are a top end and a bottom end;
one of the two caps mounted on the top end comprises a hook indirectly attached to the cap by a string.

7. The insect-trapping device as claimed in claim 3, wherein the two ends of the container are a top end and a bottom end;
one of the two caps mounted on the top end comprises a hook indirectly attached to the cap by a string.
